(19) United States
(12) Patent Application Publication
(10) Pub. No.: US 2015/0325352 A1
(43) Pub. Date: Nov. 12, 2015

(54) MAGNET FIXED DEVICE AND AN ELECTRONIC DEVICE HAVING THE SAME OR AN ACCESSORY HAVING THE SAME

(71) Applicant: Anker Technology Co., Limited, Kowloon (HK)

(72) Inventor: TIMOTHY LOWE, Sunnyvale, CA (US)

(73) Assignee: ANKER TECHNOLOGY CO., LIMITED, Kowloon (HK)

(21) Appl. No.: 14/705,431

(22) Filed: May 6, 2015

Related U.S. Application Data
(60) Provisional application No. 61/989,950, filed on May 7, 2014.

(51) Int. Cl. H01F 7/02

(52) U.S. Cl. CPC H01F 7/0252

(57) ABSTRACT

A magnetic attachment system, comprising: a first surface imbedded with a first plurality of magnets, a second surface imbedded with a second plurality of magnets, wherein the first plurality of magnets in the first surface and the second plurality of magnets in the second surface are each of magnetic polarities and are each arranged such that when the first surface and the second surface are brought within an effective magnetic range of each other, they are caused to attach or align with each other in a predetermined orientation as desired.

### RELATED APPLICATION

The present application claims priority from provisional application 61/989,950 filed on May 7, 2014, the contents of which are incorporated herein by reference.

### TECHNICAL FIELD

The present invention pertains to the field of magnetic attachment, and in particular, to a method and system of attachment and alignment using imbedded magnet arrays.

### BACKGROUND

Use of magnets to attach items to each other is known. For example Apple's US Patent Publication 20140049911 describes a magnetic attachment mechanism and method that can be used to releasably attach at least two objects together in a preferred configuration without fasteners and without external intervention. The magnetic attachment mechanism can be used to releasably attach an accessory device to an electronic device. The accessory device can be used to augment the functionality of usefulness of the electronic device. By using keyed magnets, that is a specific arrangement of magnets, add-on accessories can be optimally positioned repeatably without much fuss. These magnetic structures may be positioned on any side of the tablet body, including the bottom for use with docks and stands.

There remains, however, a need for means for attaching articles to each other in good alignment with each other for optimum use.

### SUMMARY

The present invention relates to use of is about a series of uniquely arranged magnets that can be imbedded into electronic devices or the accessories of the electronic devices.

Accordingly the present invention provides a magnetic attachment system, comprising:
a. a first surface imbedded with a first plurality of magnets,
b. a second surface imbedded with a second plurality of magnets,
   wherein the first plurality of magnets in the first surface and the second plurality of magnets in the second surface are each of magnetic polarities and each arranged such that when the first surface and the second surface are brought within an effective magnetic range of each other, they are caused to attach or align with each other in a predetermined orientation as desired.

The magnetic attraction should be strong enough that the surfaces when held together will not separate when either surface is rotated, but continue to be held together during the rotation.

In a more specific embodiment, the invention provides a magnetic attachment system wherein:

a. a first plurality of magnets in the first surface is comprised of a first central magnet (often but not necessarily circular or elliptical in shape) which is surrounded by a plurality of first surrounding magnets, for example rectangular magnets arranged length-wise radially, that are spaced apart (commonly but not necessarily in a regular pattern, such as evenly distributed around the circumference of a circle surrounding the central magnet) and the magnetic polarity of the first central magnet is opposite of that of the plurality of the surrounding magnets,

b. the second plurality of magnets in the second surface is comprised of a second central magnet (often but not necessarily circular or elliptical in shape) which is surrounded by a plurality of second surrounding magnets, for example rectangular magnets arranged length-wise radially, that are spaced apart (commonly but not necessarily in a regular pattern, such as evenly distributed around the circumference of a circle surrounding the central magnet) the number of which are equal to the numbers in the plurality of first surrounding magnets in the first surface and the magnetic polarity of the second surrounding magnets is opposite of that of the first surrounding magnets in the first surface,

c. the first surface and the second surface attaching and aligning with each other in a predetermined over-lapping orientation when the surfaces are brought within the range of magnetic attraction of each other.

In another embodiment, the magnetic attachment comprises:

a. the first plurality of magnets in the first surface is comprised of two magnets that are of opposite magnetic polarity, and are in magnetic attraction of each other, and are in contact with each other,

b. the second plurality of magnets in the second surface is comprised of two that are of opposite magnetic polarity, and are in magnetic attraction of each other, and are in contact with each other,

c. the first surface and the second surface are caused to attach and align with each other.

In this embodiment, the magnets are commonly rectangular in shape. Conveniently, contact between the magnets on each surface is along their shorter sides.

When referring to the polarity of the magnets, we mean the pole of the magnet oriented towards the exterior of the surface in which it is embedded.

The electronic devices for which such magnetic attachment systems may be used include but not limited intelligent electronic devices, USB chargers for the intelligent electronic devices, mobile power supplies and so on. The accessories include but not limited cases, support devices for the intelligent electronic devices. Those imbedded magnet arrays not only enable the devices and accessories to attach with each other, but also can direct the alignment between two parts to the desired orientation. The imbedded magnets are not visible and thus will not affect the appearance of the electronic devices or accessories.

Suitable arrangement of the magnets may permit the user to choose between different predetermined orientations of the articles into the surface of which the pluralities of magnets have been embedded. For example in the first embodiment described above if four surrounding magnets are disposed at right angles to each other, the user can choose between vertical and horizontal alignments between the two articles.

### BRIEF DESCRIPTION OF DRAWINGS

FIG. 1 is a schematic diagram of an implementation of a magnet array according to an embodiment of the present invention;

FIG. 2 is a schematic diagram of another implementation of a magnet array according to an embodiment of the present invention;

FIG. 3 is a schematic diagram of another implementation of a magnet array according to an embodiment of the present invention;

FIG. 4 is an exemplary diagram of an implementation of the magnet array according to Model A of FIG. 1 according to an embodiment of the present invention;

FIG. 5 is an exemplary diagram of an implementation of the magnet array according to Model B of FIG. 1 according to an embodiment of the present invention;

FIG. 6 is an exemplary diagram of an implementation of the magnet array according to Model E of FIG. 3 according to an embodiment of the present invention;

FIG. 7 is an exemplary diagram of an implementation of the magnet array according to a combination of FIG. 1 and FIG. 3 according to an embodiment of the present invention;

FIG. 8 is an exemplary diagram of another implementation of the magnet array according to a combination of FIG. 1 and FIG. 3 according to an embodiment of the present invention;

FIG. 9 is an exemplary diagram of an implementation of the magnet array according to a combination of Model A and Model B of FIG. 1 according to an embodiment of the present invention;

### DESCRIPTION OF EMBODIMENTS

To make the objectives, technical solutions, and advantages of the present invention clearer and more comprehensible, the following further describes the present invention in detail with reference to the accompanying drawings and embodiments. It should be understood that the specific embodiments described herein are merely used to explain the present invention but are not intended to limit the present invention.

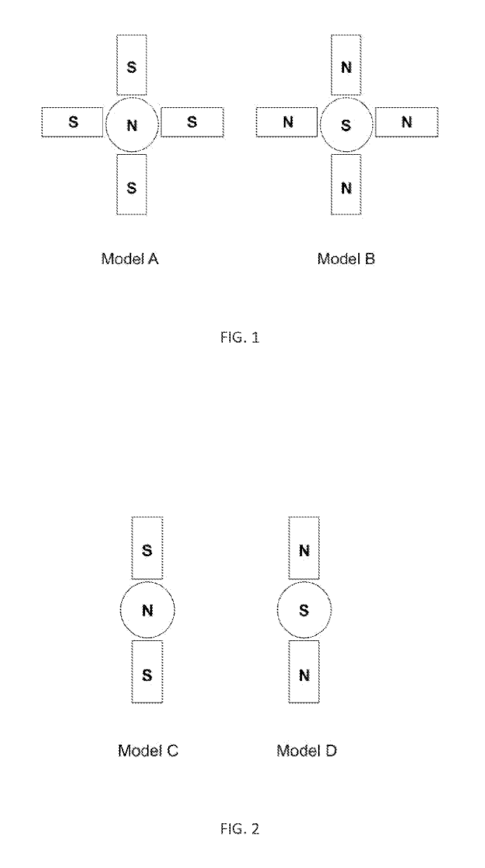

The first series of magnet arrangements is shown in FIG. 1, in which a central round magnet is surrounded by four 90-degree-seperated rectangular magnets and the magnetic poles of the central and surrounding magnets are designed to be opposite to make sure two overlapping models will attach only at the right position.

The second series of magnet arrangements is shown in FIG. 2. The magnet arrangements are the same as the first series except the central round magnet is surround by two 180-degree-seperated rectangular magnets.

When Model A overlaps with Model B or Model D, the magnetic force will hold them together and adjust automatically to adopt such an orientation that all surrounding magnets overlap perfectly. External force can be used to rotate one model and the design of a central round magnet ensures an even attracting force during the rotation.

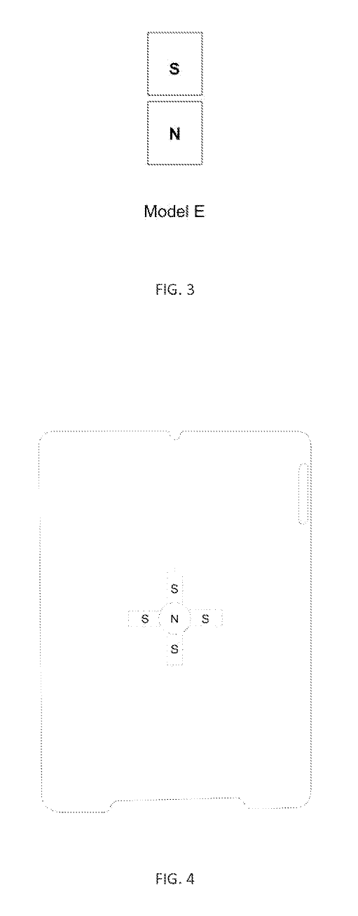

The third series is shown in FIG. 3, in which two magnets with opposite magnetic poles are placed together. Similarly, this design ensures two overlapping models will attach only at the right position. When two sets of Model E are held together, the attracting force will orient the magnets to such a position that N-magnets overlap with S-magnets.

In the case of model E being held together with Model A or Model C, the magnetic force will orient the S-magnet in Model E to overlap with the central IN-magnet of Model A and the N-magnet in Model E to overlap with one of the surround S-magnets in Model A. The situation is similar between Model E with Model B and Model D.

Below is one example of the applications of the above magnet models in electronic devices and accessories.

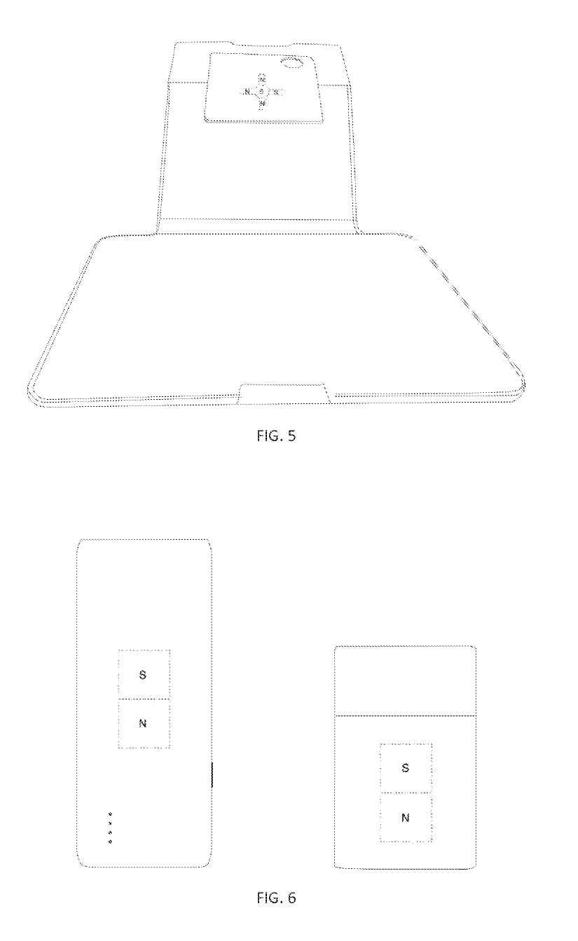

Model A is imbedded into a tablet protective case (FIG. 4), whereas Model B is imbedded into the protective folio (FIG. 5). Model E is used in power supplying devices like external battery, wall charger, desktop charger and car charger (FIG. 6).

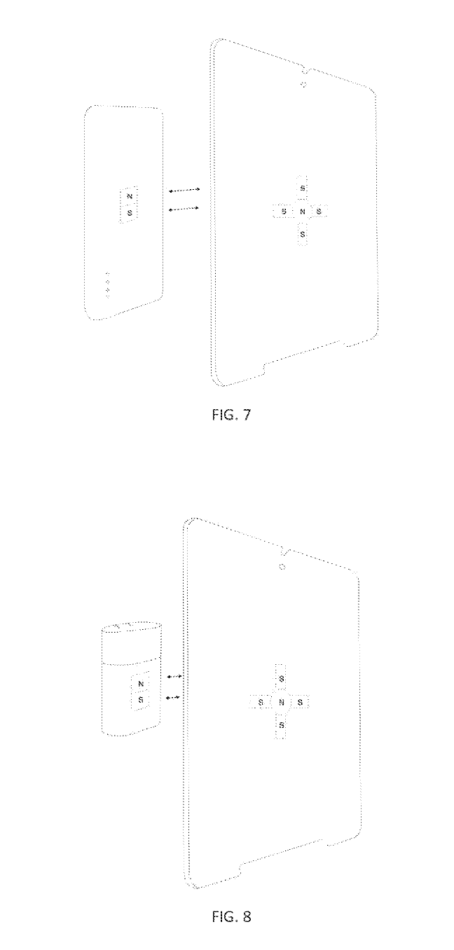

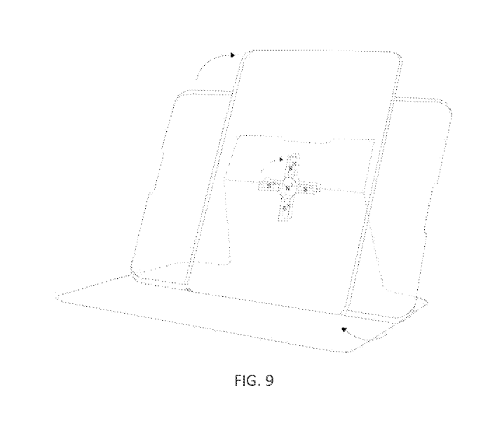

With the help of the imbedded magnet models, these electronic devices and accessories can easily attach with each other when necessary and separate when the job is done. For example, a cellphone case can attach to an external battery or wall charger while charging (FIG. 7, 8); a folio can attach to the tablet case to provide front protection and together function as a stand (FIG. 9). The arrangements of magnets and magnetic poles can help to direct the attaching position and make the alignment between two parts easy. For example, when an external battery with Model E is attached to a cellphone case with Model C, the battery will adopt a parallel orientation and be directed to the center of the case where two magnet modes have maximum overlap (FIG. 7).

In the case of tablet protective case and folio, the imbedded magnet Model A and B can hold the two parts together by magnetic force, even when external force is applied to rotate the case. During rotation the attracting force between the surrounding magnets in two magnet models will automatically direct the protective case to adopt a landscape or portrait position and thus makes changing viewing angles of the tablet more convenient (FIG. 9).

Magnets suitable for use in the present invention may be formed from ferromagnetic materials such as permanent magnets made of alloys of iron, cobalt, nickel, and nickel- and cobalt-containing aluminum alloys such as Alnico. Ferrite (ceramic) magnets may also be of use in some applications.

The dimensions of the magnets will be chosen according to the particular surfaces that they are to be used to attract to each other. In many instances, thin magnets may be desired. In situations where very thin magnets are needed, high magnetization permanent magnets such as Nd—Fe—B and Sm—Fe—N may be useful.

Magnets may be embedded into the surfaces in which they are used in any convenient way. For example when embedded into the surface of an article made of a thermoplastic or coated with a thermoplastic material, the thermoplastic may be heated to a softness permitting the magnets to be placed in position or in some cases, the magnets may be prepositioned and molten thermoplastic added and allowed to solidify on cooling. In cases where the surface is made of a thermosetting plastic, the magnets will be prepositional and liquid thermoplastic resin added to surround them and then heated to effect solidification of the plastic.

In one example, the magnetic attachment system of the present invention may be used in portable power supplies and chargers, wherein the magnets are incorporated in the inside surface of the shell of the portable power supply. The magnets are very thin, on for the skilled person, ifs not hard to embody the magnets into the electronic device.

The attachment system can also be employed to cause attachment of more than one dependent product. For examples, two or three products need to be used together.

For example, for chargers and phone cases, usually, users only use the phone cases. But when he/she need to charge his/her phone, and the charger is a wall charger where the pins of the charger are inserted into a socket without the need for a cable, he/she could attached his/her phone to the charger, so that he/she could not need a long cable. In another example, the magnetic attachment system is used with a case and folio for a tablet computer, the user can not only use the case for his tablet, but also attaches the folio to the case. So that the folio could cover the tablet.

1. A magnetic attachment system, comprising:
a. a first surface imbedded with a first plurality of magnets,
b. a second surface imbedded with a second plurality of magnets,
wherein the first plurality of magnets in the first surface and the second plurality of magnets in the second surface are each of magnetic polarities and are each arranged such that when the first surface and the second surface are brought within an effective magnetic range of each other, they are caused to attach or align with each other in a predetermined orientation as desired.

2. The magnetic attachment system of claim wherein:
a. a first plurality of magnets in the first surface is comprised of a first central magnet which is surrounded by a plurality of first and the magnetic polarity of the first central magnet is opposite of that of the plurality of the surrounding magnets,
b. the second plurality of magnets in the second surface is comprised of a second central magnet which is surrounded by a plurality of second surrounding magnets, the number of which are equal to the numbers in the plurality of first surrounding magnets in the first surface and the magnetic polarity of the second surrounding magnets is opposite of that of the first surrounding magnets in the first surface,
c. the first surface and the second surface attaching and aligning with each other in a predetermined over-lapping orientation when the surfaces are brought within the range of magnetic attraction of each other.

3. The magnetic attachment system as claimed in claim 2, wherein said central magnets are circular or elliptical in shape.

4. The magnetic attachment system as claimed in claim 2, wherein the surrounding magnets are rectangular magnets.

5. The magnetic attachment system as claimed in claim 4, wherein said rectangular magnets are arranged length-wise radially and are spaced apart.

6. The magnetic attachment system as claimed in claim 5, wherein said rectangular magnets are evenly distributed around the circumference of a circle surrounding the central magnet.

7. The magnetic attachment system of claim 1, wherein:
a. the first plurality of magnets in the first surface is comprised of a first central circular-like magnet which is surrounded by four rectangular-like of a first surrounding magnets, arranged length-wise radially, that are spaced an equal number of degrees apart, and the magnetic polarity of the central circular-like magnet is opposite of that of the four of a first surrounding rectangular-like magnets,
b. the second plurality of magnets in the second surface is comprised of a second central circular-like magnet of a polarity opposite to that of the first central circular-like magnet in the first surface, which is surrounded by two rectangular-like of a second surrounding magnets, arranged length-wise radially, that are spaced an equal number of degrees apart, and the magnetic polarity of the rectangular-like two of a second surrounding magnets is opposite of that of the four of a first surrounding rectangular-like magnets in the first surface,
c. the first surface and the second surface are caused to attach and align with each other in a predetermined over-lapping orientation, and can be rotated about the common central axis of the central circular-like magnets through the use of an external force while maintaining an even attracting force during the rotation.

8. The magnetic attachment system of claim 1, wherein:
a. the first plurality of magnets in the first surface is comprised of two magnets that are of opposite magnetic polarity, and are in magnetic attraction of each other, and are in contact with each other,
b. the second plurality of magnets in the second surface is comprised of two that are of opposite magnetic polarity, and are in magnetic attraction of each other, and are in contact with each other,
c. the first surface and the second surface are caused to attach and align with each other.

9. The magnetic attachment system of claim 8, wherein the magnets are rectangular in shape and are in contact with each other on their respective width edges.

10. The magnetic attachment system of claim 1, wherein:
a. the first plurality of magnets in the first surface is comprised of two rectangular-like magnets that are of opposite magnetic polarity, and are in magnetic attraction of each other, and are in contact with each other on their respective width edges,
b. the second plurality of magnets in the second surface is comprised of a second central circular-like magnet which is surrounded by rectangular-like a plurality of second surrounding magnets, arranged length-wise radially, that are spaced an equal number of degrees apart, and the magnetic polarity of the second central circular-like magnet is opposite of that of the plurality of second surrounding rectangular-like magnets,
c. the first surface and the second surface are caused to attach and align with each other such that one of the first plurality of two rectangular-like magnets in the first surface is caused to attach to the second central circular-like magnet of the second surface, and the other of the first plurality of magnets two rectangular-like magnets in the first surface is caused to attach to one of the plurality of second surrounding rectangular-like magnets of the second surface.

11. A method of attaching or aligning two surfaces, comprising:
a. providing a first surface imbedded with a first plurality of magnets,
b. providing a second surface imbedded with a second plurality of magnets,
c. wherein the first surface and the second surface are caused to attach or align with each other in a predetermined orientation,
d. using the first surface as a first part of a device, and using the second surface as a second part of the device, and bringing the two parts in close proximity so that magnetic forces will hold them together and adjust automatically to adopt such an orientation that the first plurality of magnets and the second plurality of magnets all surrounding magnets overlap precisely, and when an external force is applied to rotate the first surface, during the rotation the attracting force between the first plurality of magnets and the second plurality of magnets surrounding magnets in the two surfaces wilt automatically direct the second surface to rotate in synchronization, and can separate as desired.

12. The method of claim 11, wherein:
a. the first plurality of magnets in the first surface is comprised of a central circular-like magnet which is surrounded by rectangular-like a plurality of first surrounding magnets, arranged length-wise radially, that are spaced an equal number of degrees apart, and the magnetic polarity of the first central circular-like magnet is opposite of that of the plurality of first surrounding rectangular-like magnets,
b. the second plurality of magnets in the second surface is comprised of a second central circular-like magnet of a polarity opposite to that of the first central circular-like magnet in the first surface, which is surrounded by a plurality of second surrounding magnets the number of which are equal to the number in the plurality of first surrounding magnets in the first surface, that are spaced apart, and the magnetic polarity of the plurality of second surrounding magnets is opposite of that of the plurality of first surrounding the same number of rectangular-like magnets, as in the first surface, that are spaced an equal number of degrees apart, and the magnetic polarity of the rectangular-like magnets is opposite of that of the rectangular-like magnets in the first surface,
c. the first surface and the second surface are caused to attach and align with each other in a predetermined over-lapping orientation.

13. The method of claim 11, wherein:
a. the first plurality of magnets in the first surface is comprised of a first central magnet which is surrounded by four of a first surrounding magnets, arranged length-wise radially, that are spaced apart, and the magnetic polarity of the central magnet is opposite of that of the four of a first surrounding magnets the plurality of magnets in the first surface is comprised of a central circular-like magnet which is surrounded by four rectangular-like magnets, arranged length-wise radially, that are spaced an equal number of degrees apart, and the magnetic polarity of the central circular-like magnet is opposite of that of the surrounding rectangular-like magnets,
b. the second plurality of magnets in the second surface is comprised of a second central magnet of a polarity opposite to that of the first central magnet in the first surface, which is surrounded by two of a second surrounding magnets, arranged length-wise radially, that are spaced apart, and the magnetic polarity of the two of a second surrounding magnets is opposite of that of the four of a first surrounding magnets in the first surface the plurality of magnets in the second surface is comprised of a central circular-like magnet of a polarity opposite to that of the central circular-like magnet in the first surface, which is surrounded by two rectangular-like magnets, arranged length-wise radially, that are spaced an equal number of degrees apart, and the magnetic polarity of the rectangular-like magnets is opposite of that of the rectangular-like magnets in the first surface,
c. the first surface and the second surface are caused to attach and align with each other in a predetermined over-lapping orientation, and can be rotated about the common central axis of the central circular-like magnets through the use of an external force while maintaining an even attracting force during the rotation.

14. The method of claim 11, wherein:
a. the first plurality of magnets in the first surface is comprised of two magnets that are of opposite magnetic polarity, and are in magnetic attraction of each other, and are in contact with each other on their respective width edges the plurality of magnets in the first surface is comprised of two rectangular-like magnets that are of apposite magnetic polarity, and are in magnetic attraction of each other, and are in contact with each other on their respective width edges,
b. the second plurality of magnets in the second surface is comprised of two magnets that are of opposite magnetic polarity, and are in magnetic attraction of each other, and are in contact with each other on their respective width edges the plurality of magnets in the second surface is comprised of two rectangular-like magnets that are of opposite magnetic polarity, and are in magnetic attraction of each other, and are in contact with each other on their respective width edges,
c. the first surface and the second surface are caused to attach and align with each other.

15. The method of claim 11, wherein:
a. the first plurality of magnets in the first surface is comprised of two magnets that are of opposite magnetic polarity, and are in magnetic attraction of each other, and are in contact with each other on their respective width edges the plurality of magnets in the first surface is comprised of two rectangular-like magnets that are of opposite magnetic polarity, and are in magnetic attraction of each other, and are in contact with each other on their respective width edges,
b. the second plurality of magnets in the second surface is comprised of a second central magnet which is surrounded by a plurality of second surrounding magnets, arranged length-wise radially, that are spaced apart, and the magnetic polarity of the second central magnet is opposite of that of the plurality of second surrounding magnets the plurality of magnets in the second surface is comprised of a central circular-like magnet which is surrounded by rectangular-like magnets, arranged length-wise radially, that are spaced an equal number of degrees apart, and the magnetic polarity of the central circular-like magnet is opposite of that of the surrounding rectangular-like magnet,
c. the first surface and the second surface are caused to attach and align with each other such that one of the first plurality of magnets in the first surface is caused to attach to the second central magnet of the second surface, and the other of the first plurality of magnets in the first surface is caused to attach to one of the plurality of second surrounding magnets of the second surface the first surface and the second surface are caused to attach and align with each other such that one of the two rectangular-like magnets in the first surface is caused to attach to the central circular-like magnet of the second surface, and the other of the two rectangular-like magnets in the first surface is caused to attach to one of the surrounding rectangular-like magnets of the second surface.

16. An electronic device incorporating a magnetic attachment system, comprising:
a. a first surface imbedded with a first plurality of magnets,
b. a second surface imbedded with a second plurality of magnets,
wherein the first plurality of magnets in the first surface and the second plurality of magnets in the second surface are each of magnetic polarities and are each arranged such that when the first surface and the second surface are brought within an effective magnetic range of each other, they are caused to attach or align with each other in a predetermined orientation as desired.

17. An electronic device as claimed in claim 16, wherein said magnetic attachment system comprises
a. a first plurality of magnets in the first surface is comprised of a first central magnet which is surrounded by a plurality of first and the magnetic polarity of the first central magnet is opposite of that of the plurality of the surrounding magnets,
b. the second plurality of magnets in the second surface is comprised of a second central magnet which is surrounded by a plurality of second surrounding magnets, the number of which are equal to the numbers in the plurality of first surrounding magnets in the first surface and the magnetic polarity of the second surrounding magnets is opposite of that of the first surrounding magnets in the first surface,
c. the first surface and the second surface attaching and aligning with each other in a predetermined over-tapping orientation when the surfaces are brought within the range of magnetic attraction of each other.

18. An electronic device as claimed in claim 16, wherein
a. the first plurality of magnets in the first surface is comprised of two magnets that are of opposite magnetic polarity, and are in magnetic attraction of each other, and are in contact with each other,
b. the second plurality of magnets in the second surface is comprised of two that are of opposite magnetic polarity, and are in magnetic attraction of each other, and are in contact with each other,
c. the first surface and the second surface are caused to attach and align with each other.

19. An electronic device as claimed in claim 16, which is selected from the group consisting of a USB chargers for the intelligent electronic devices, and mobile power supplies.

20. A case or support devices for an intelligent electronic device which comprises a magnetic attachment system as claimed in claim 1.
